(19) United States
(12) Patent Application Publication
(10) Pub. No.: US 2022/0237724 A1
(43) Pub. Date: Jul. 28, 2022

(54) SYSTEMS AND METHODS FOR COLLEGE RECRUITMENT THAT PROTECT EDUCATIONAL DATA AND PROVIDE SAFETY FOR STUDENTS AND MINORS

(71) Applicant: Michael Cardinal, Goshen, CT (US)

(72) Inventor: Michael Cardinal, Goshen, CT (US)

(21) Appl. No.: 17/480,981

(22) Filed: Sep. 21, 2021

Related U.S. Application Data
(60) Provisional application No. 63/141,559, filed on Jan. 26, 2021.
(60) Provisional application No. 63/238,438, filed on Aug. 30, 2021.

(51) Int. Cl. G06Q 50/20; G06Q 30/00; G06F 16/9535

(52) U.S. Cl. CPC G06Q 50/2053; G06F 16/9535; G06Q 30/018

(57) ABSTRACT

Systems and methods are included that allow minors and other students to safely and securely research and communicate with administrators from universities and colleges that they are interested in attending, that provide guardian oversight, and that allow high schools to be better engaged in the college admissions process.

### CROSS-REFERENCE TO RELATED APPLICATIONS

The present application claims priority to U.S. Provisional Application No. 63/141,559 filed Jan. 26, 2021, titled “SYSTEM AND METHOD FOR COLLEGE SEARCHING AND MATCHING THAT PROTECTS EDUCATIONAL DATA OF STUDENTS AND MINORS” and U.S. Provisional Application No. 63/238,438 filed Aug. 30, 2021, titled “SYSTEM AND METHOD FOR COLLEGE RECRUITMENT THAT PROTECTS EDUCATIONAL DATA OF STUDENTS AND MINORS,” both of which are hereby incorporated by reference in their entireties.

### TECHNICAL FIELD

The present disclosure relates to systems and methods for protecting students and minors and their data by using validation processes, building personal profiles, and searching and connecting with colleges and universities.

### BACKGROUND

The college selection and admissions process generally involves minors and other students researching, communicating with, and applying to institutions of higher education, such as colleges and universities. Minors and their parents and guardians generally start researching colleges and universities as early as middle school (approximately age thirteen and in some cases even younger) and continue with the process through admission to about age seventeen.

The college and university admissions process can be time-consuming, challenging, and often overwhelming due to the amount of research and information that minor students and their parents and guardians must review. Faculty at high schools, colleges, and universities can be an invaluable resource in helping students make the best choice for their future education; however, since the majority of students applying to colleges and universities are minors, data privacy and safety are important concerns. Further, laws have even been passed that govern the type of information and manner in which minors' information can be shared. One such law is the Family Educational Rights and Privacy Act (FERPA), a United States federal law enacted in 1974 that protects the privacy of student education records. FERPA applies to all schools that receive funds under applicable portions of the U.S. Department of Education and thus governs a vast number of schools in the United States.

With the rise and ubiquity of the internet as a communication facilitation tool, communication platforms of various types been created and implemented to varying degrees of success. Many of the most successful communication platforms have been grouped under the term “social media.” With few exceptions, modern social media platforms do not require that their users be validated in order to create accounts and use their platforms. As such, virtually anyone of a certain age (or claiming to be of a certain age) can create an anonymous or referential username and/or handle for themselves or their business or organization, build a profile, and connect with other individuals and entities. Unfortunately, unscrupulous and even criminal behavior does occur online and on social media platforms. In many instances bad behavior can be reduced by requiring account validation, since people are less likely to commit indecent acts that can be easily traced back to themselves when their account is validated through government identification or otherwise.

Existing college preparation and readiness software (e.g., Naviance, Scoir, and others) generally charge schools per year to use their software and are generally just a repository for grades, transcripts, and applications; however, no existing full-service platforms that allow students to interact with college representatives, administrators, and others have safety and security built in and allow students and guardians to research and communicate safely.

For the foregoing reasons, there is a need for platforms and validation processes that protect minors and allow for students to research institutions of higher learning and their various programs and communicate with representatives at such institutions of higher learning.

### SUMMARY

In various embodiments, systems and methods for protecting and validating minor students' profiles on a university researching and matching platform are described. Some embodiments comprise checking students' ages and communicating with guardians to request consent before allowing minor students to communicate with college and university administrators via the platform, while allowing some other restricted functionality or preventing access altogether.

The configuration of the systems and methods described herein in detail are only example embodiments and should not be considered limiting. Other systems, devices, methods, features, and advantages will be or will become apparent to one with skill in the art upon examination of the following figures and detailed description. It is intended that all such systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

Additional features and advantages of the embodiments disclosed herein will be set forth in the detailed description that follows and will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof. Moreover, all illustrations are intended to convey concepts, where relative sizes, shapes, and other detailed attributes may be illustrated schematically rather than literally or precisely.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a flowchart diagram showing a full process for a non-validated student sign-up (No Social Access), in accordance with some embodiments described herein;

FIG. 2 is a flowchart diagram showing an emancipation process for a non-validated student sign-up (No Social Access), in accordance with some embodiments described herein;

FIG. 3 is a flowchart diagram showing a full process for a validation of a non-validated student (Grant Social Access), in accordance with some embodiments described herein;

FIG. 4 is a flowchart diagram showing a validation process of an imported high school student, in accordance with some embodiments described herein;

FIG. 5 is a flowchart diagram showing a validation process of an imported high school student (Guardian Email First, no external email allowed), in accordance with some embodiments described herein;

FIG. 6 is a flowchart diagram showing a grant social access process for a student upon turning eighteen, in accordance with some embodiments described herein;

FIG. 7 is a flowchart diagram showing a school notification process for a validated student sign-up, in accordance with some embodiments described herein;

FIG. 8 is a flowchart diagram showing a new high school onboarding process, in accordance with some embodiments described herein;

FIG. 9 is a flowchart diagram showing a new institution onboarding process, in accordance with some embodiments described herein;

FIG. 10 is a system architecture diagram, in accordance with some embodiments described herein;

FIG. 11A is a user interface screenshot of a student profile, in accordance with some embodiments described herein;

FIG. 11B is a user interface screenshot of a student profile, in accordance with some embodiments described herein;

FIG. 12 is a user interface screenshot of a school recommendation page, in accordance with some embodiments described herein;

FIG. 13 is a user interface screenshot of a matching institution scoring page, in accordance with some embodiments described herein;

FIG. 14 is a user interface screenshot of a school profile administrator, in accordance with some embodiments described herein;

FIG. 15 is a user interface image of a system menu with system buttons, in accordance with some embodiments described herein;

FIG. 16 is a user interface screenshot of a message composition window, in accordance with some embodiments described herein;

FIG. 17 is a user interface screenshot of a message management page, in accordance with some embodiments described herein;

FIG. 18 is a user interface screenshot of a financial profile page, in accordance with some embodiments described herein;

FIG. 19 is a user interface screenshot of an institution profile page, in accordance with some embodiments described herein;

FIG. 20 is a user interface screenshot of a student profile page, in accordance with some embodiments described herein;

FIG. 21 is a user interface screenshot of a newsfeed page, in accordance with some embodiments described herein;

FIG. 22 is a user interface screenshot of an institution search page, in accordance with some embodiments described herein;

FIG. 23 is a user interface screenshot of an appointments page, in accordance with some embodiments described herein;

FIG. 24 is a user interface screenshot of a mobile device store, in accordance with some embodiments described herein;

FIG. 25 is a user interface screenshot of a system application login screen, in accordance with some embodiments described herein;

FIG. 26 is a user interface screenshot of a system application user profile screen, in accordance with some embodiments described herein;

FIG. 27 is a user interface screenshot of a system application messaging screen, in accordance with some embodiments described herein; and

FIG. 28 is a user interface screenshot of a system application institution search filter screen, in accordance with some embodiments described herein.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Reference will now be made in detail to the present preferred embodiment(s), and examples of which is/are illustrated in the accompanying drawings. Whenever possible, the same reference numerals will be used throughout the drawings to refer to the same or like parts.

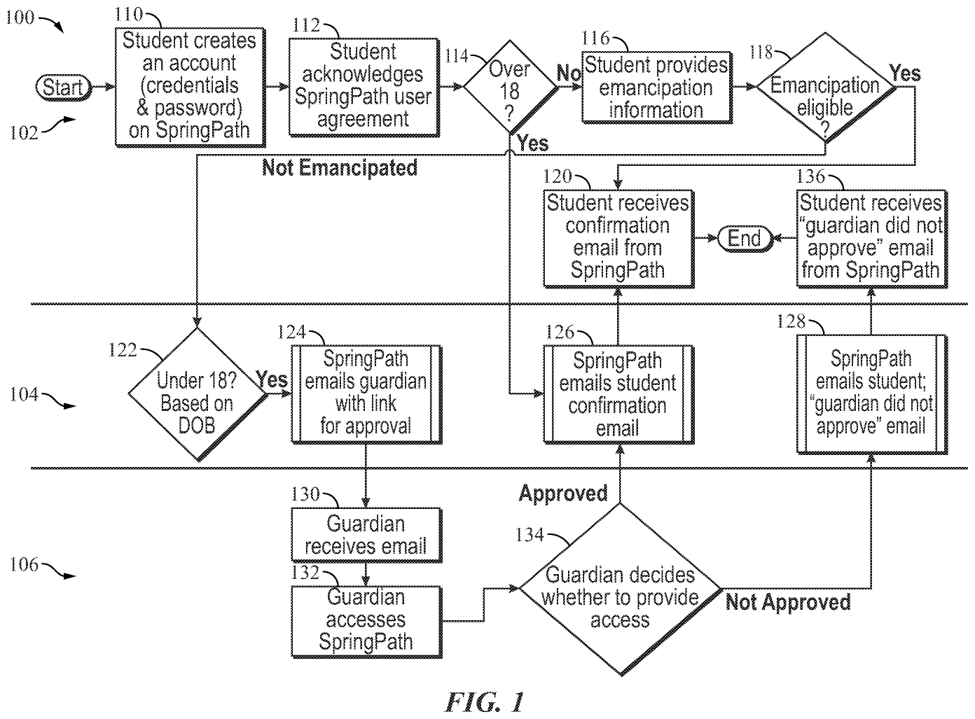

FIG. 1 is a flowchart diagram 100 showing a full process for a non-validated student sign-up (No Social Access), in accordance with some embodiments described herein. As shown in the example embodiment, students, parents, and/or guardians may be involved in the process of signing students up with the system. Diagram 100 shows a student portion 102 including actions and responses interacting with the system portion 104 and guardian portion 106. Initially, a student can create an account with the system by visiting a website and/or accessing an application on a phone, computer, tablet, or other device. In step 110 the student can create an account, including creating credentials and/or usernames and passwords with the system. Next in step 112, the student can be presented with, review, and acknowledge user agreement(s) on the device. The system can prompt the student to confirm whether they are an adult or over eighteen in step 114. If the student is over eighteen, the system can confirm with the student by sending them an email in step 126 to confirm their account in step 128. If the student is under eighteen, the system can prompt the student to enter any emancipation information in step 116 they may have using one or more questions and answers in step 118. The system can then determine if the student is emancipation eligible in step 120. If the student is eligible, they can receive a confirmation email and their account will be set up in step 120. If the system determines that the student is not emancipation eligible, it can check whether they are under eighteen based on the student's date of birth in step 122. If they are under eighteen, in step 124 the system can prompt the student for contact information of their parent or guardian or can otherwise contact the parent or guardian for approval if the information is already known by the system. The guardian can then receive the email in step 130, access the platform in step 132, and decide whether to approve access for the student in step 134. If the guardian approves, then the system can send a confirmation email to the student in step 126. If the guardian disapproves, then in step 128 the system can send a message to the student that the guardian did not approve their sign-up, which the student can receive in step 136.

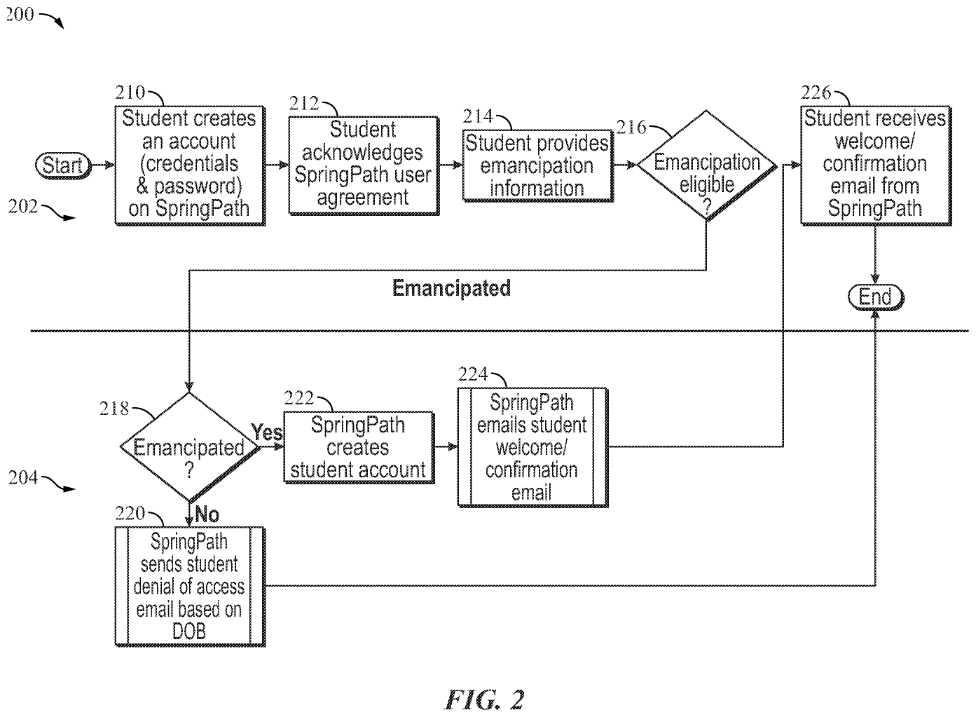

FIG. 2 is a flowchart diagram 200 showing an emancipation process for a non-validated student sign-up (No Social Access), in accordance with some embodiments described herein. As shown in the example embodiment, students 202 may sign themselves up with the system 204. Initially, a student can create an account with the system by visiting a website and/or accessing an application on a phone, computer, tablet, or other device. Creating an account in step 210 can include creating credentials and/or usernames and passwords with the system. Next the student can be presented with, review, and acknowledge user agreement(s) on the device in step 212. If the student is under eighteen, the system can prompt the student to enter any emancipation information they may have using one or more questions and answers in step 214. In step 216 the system can then determine if the student is emancipation eligible in step 218. If the student is not emancipated, the system can send them a denial of access email or message based on date of birth information in step 220. If the student is emancipated, in step 222 the system can create a student account using the information the student has added and any other information the system may have stored or accessible. The system can then email or message the student in step 224 with a welcome and/or confirmation message and/or instructions, which the student can then receive in step 226.

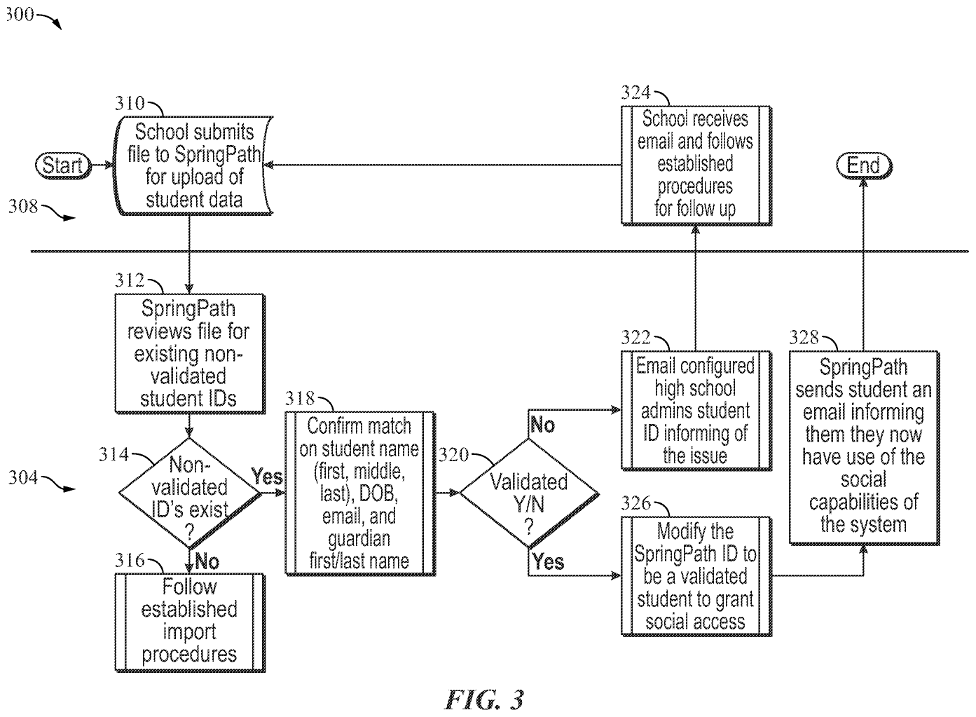

FIG. 3 is a flowchart diagram 300 showing a full process for a validation of a non-validated student (Grant Social Access), in accordance with some embodiments described herein. As shown in the example embodiment, secondary or high schools 308 can validate non-validated students by interacting with the system 304. As an initial step 310, the school can submit a file to the system 304 via hardcopy or uploaded to system database(s)/server(s). After receiving the uploaded student data in step 312, the system 304 can automatically review the file for existing non-validated student identifiers (e.g., student IDs or others) in step 314. If a non-validated identifier does not exist, then in step 316 established import procedure(s) is/are followed. Otherwise, if a validated identifier does exist, then in step 318 the system 304 confirms a match using one or more of the student names (first, middle, and/or last/surname), date of birth, email, and guardian name (first, middle, and/or last/surname) or others. The system 304 can then determine whether validation occurred in step 320. If yes, in step 326 the system can modify a system identifier (e.g., an ID) to a validated student to grant social access before sending the student an email informing them that they now have use of the social capabilities of the system 304 in step 328. If no validation was determined in the validation step 320, then in step 322 the system 304 can have an email sent to configured high school administrators with a student identifier (e.g., an ID) informing them of the issue. The school may then receive the email in step 324 and follow established procedures for follow-up in step and the school can submit an updated file to the system 304 in step 310.

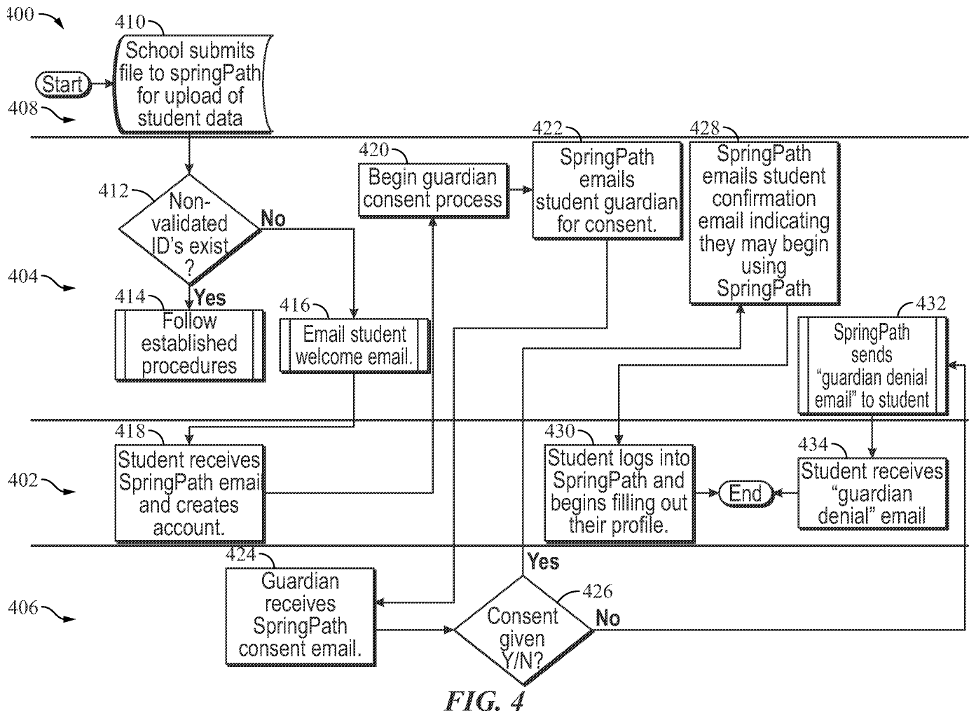

FIG. 4 is a flowchart diagram 400 showing a validation process of an imported high school student, in accordance with some embodiments described herein. As shown in the example embodiment, a high school 408, the system 404 and guardian(s) 406 can all be involved in the process. Initially in step 410, the high school can first submit a file to the system 404 via hardcopy or uploaded to system database(s)/server(s). After receiving the uploaded student data, in step 412 the system 404 can automatically review the file for existing non-validated student identifiers (e.g., student IDs or others). If a non-validated identifier exists, then in step 414 the system 404 can follow established procedures. Otherwise, if a non-validated ID does not exist, in step 416 a welcome or initiation email can be sent to the corresponding student 402. In step 418, once the student 402 receives the email, they can create an account with the system 404. The system 404 can then begin a guardian consent process in step 420, including emailing and/or otherwise contacting the student's guardian 406 in step 422. Once the guardian 406 has received the email in step 424, they can review and consent or disapprove in step 426. If they choose not to consent, in step 432 the system 404 may then contact the student 402 via email or otherwise and inform them of the guardian's 406 decision. Otherwise, if the guardian 406 does consent, then in step 428 the system 404 can contact the student 402 with a confirmation that indicates the student 402 may begin using system features. The student 402 is then able to login and access the system 404 and fill out their profile and use other system features in step 430.

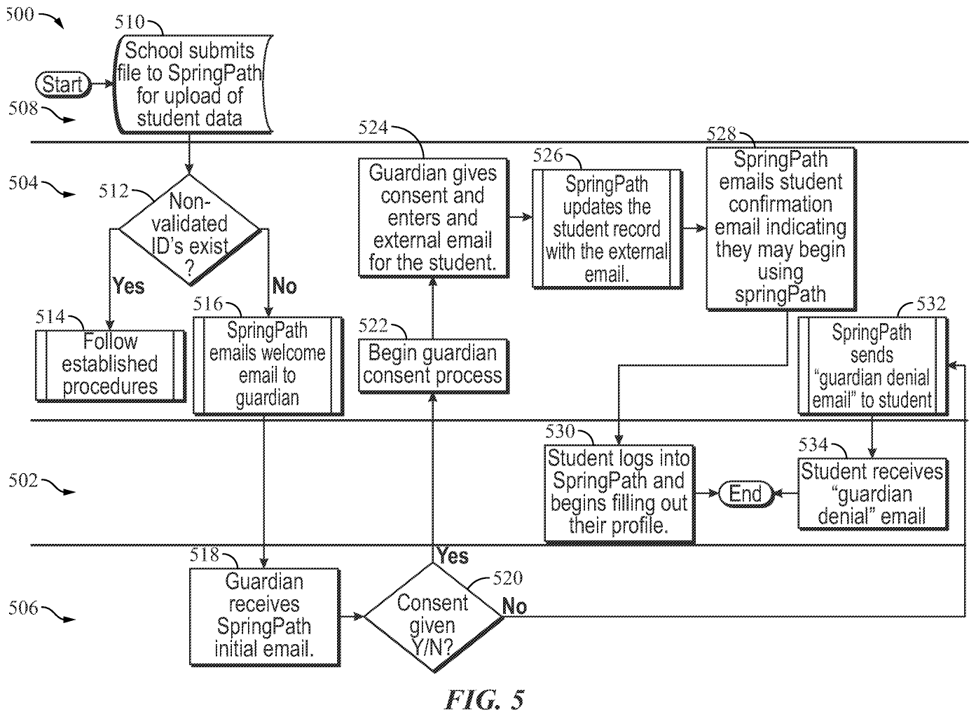

FIG. 5 is a flowchart diagram 500 showing a validation process of an imported high school student (Guardian Email First, no external email allowed), in accordance with some embodiments described herein. As shown in the example embodiment, a high school 508, the system 504, guardian(s) 506, and student 502 can all be involved in the process. As shown in the example embodiment, in step 510 a high school 508 can first submit a file to the system 504 via hardcopy or uploaded to the system database(s)/server(s). After receiving the uploaded student data, the system 504 can automatically review the file for existing non-validated student identifiers (e.g., student IDs or others) in step 512. If a non-validated identifier exists, then in step 514 the system 504 can follow established procedures. Otherwise, if a non-validated ID does not exist, in step 516 a welcome or initiation email can be sent to a guardian 506 associated with a student 502 in step 518. Once received, the guardian 506 can click a link embedded in the email or otherwise respond or reply by granting, withholding, or declining their consent in step 520. If the guardian 506 grants their consent, the system 504 can begin a guardian consent process in step 522, the guardian 506 can give consent and enter an external email address for the student 502 in step 524, and a student's external contact information, such as an email address as entered by the guardian 506, can be added or updated for the student's record in step 526. In step 528 the system 504 can then send a message to the student's email address confirming and/or activating the student's use of the system. The student 502 is then able to log into the system 504, fill out their profile, and/or use other system features in step 530. Alternatively, if the guardian 506 declines to give their consent in step 520, the system 504 can update its records accordingly and notify the student 502 via email or otherwise that consent was declined by the guardian 506 in step 532, which the student 502 can receive in step 534.

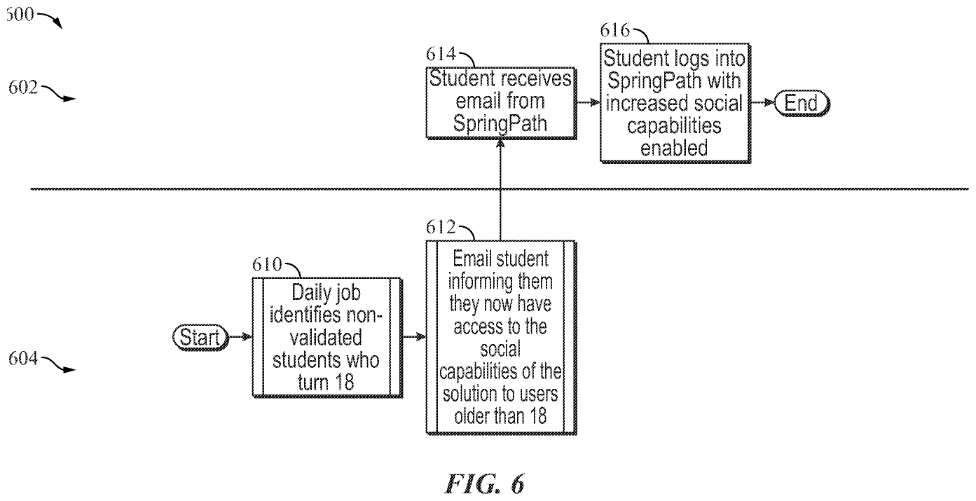

FIG. 6 is a flowchart diagram 600 showing a grant social access process for a student upon turning eighteen, in accordance with some embodiments described herein. As shown in the example embodiment, the system 604 and a student 602 can interact in the process, including a first step 610 having automated internal checking by the system 604 of minor students' 602 ages using a daily “job” or other process. This daily job can check students' 602 profile information for a date of birth (e.g., in a field or otherwise), compare with a current date (based on a physical system headquarters, student location, or otherwise), and determine if the student 602 is eighteen years old or is otherwise a legal adult. If the system 604 identifies that a non-validated student 602 has turned eighteen, in step 612 the system 604 can notify the student 602 (e.g., by sending an email to the email address on file) that the student 602 now has access to additional system features, such as social capabilities, elements, and/or features that were previously blocked for the student 602. When the student 602 receives the notification in step 614, they are able to log into the system 604 and access and use the additional features in step 616.

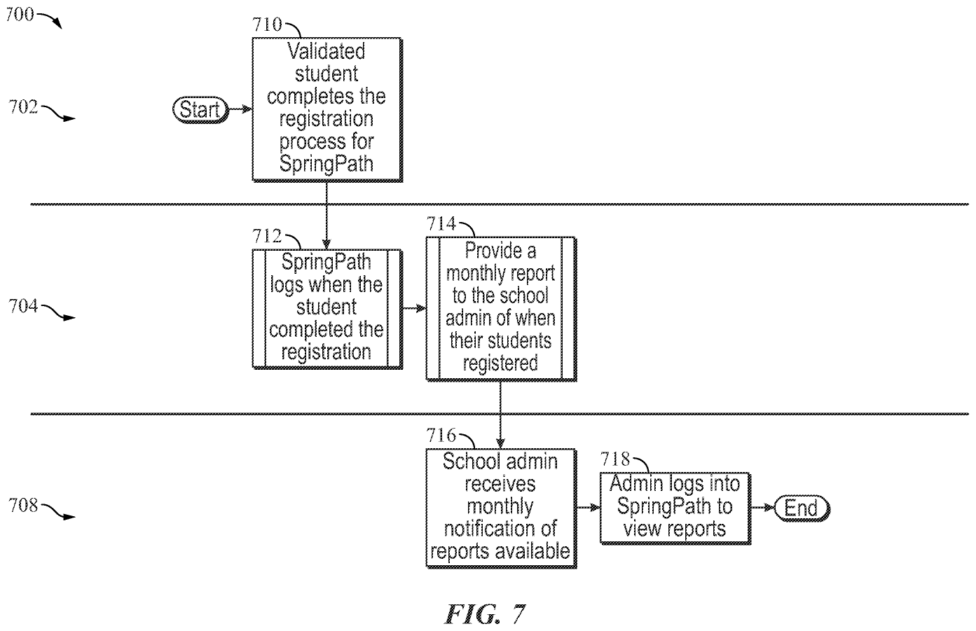

FIG. 7 is a flowchart diagram 700 showing a school notification process for a validated student sign-up, in accordance with some embodiments described herein. As shown in the example embodiment, a high school 708, the system 704, and student 702 can all be involved in the process. In a first step 710, a validated student 702 can initially complete the registration process for the system 704 by filling in an adequate amount of information with the system 704. Once complete, in step 712 the system 704 can log a timestamp and/or date stamp of when the student 702 completed the registration process. The system 704 can then run one or more reporting protocols for the registered student 702 that are sent to or accessible by school administrator(s) (e.g., a monthly, weekly, or daily report) and provide a report indicating when students 702 registered and/or other pertinent information in step 714. In some instances, a notification can be sent to school administrator(s) which can be received in step 716, before the administrator(s) can then log into the system 704 to view the report(s) in step 718.

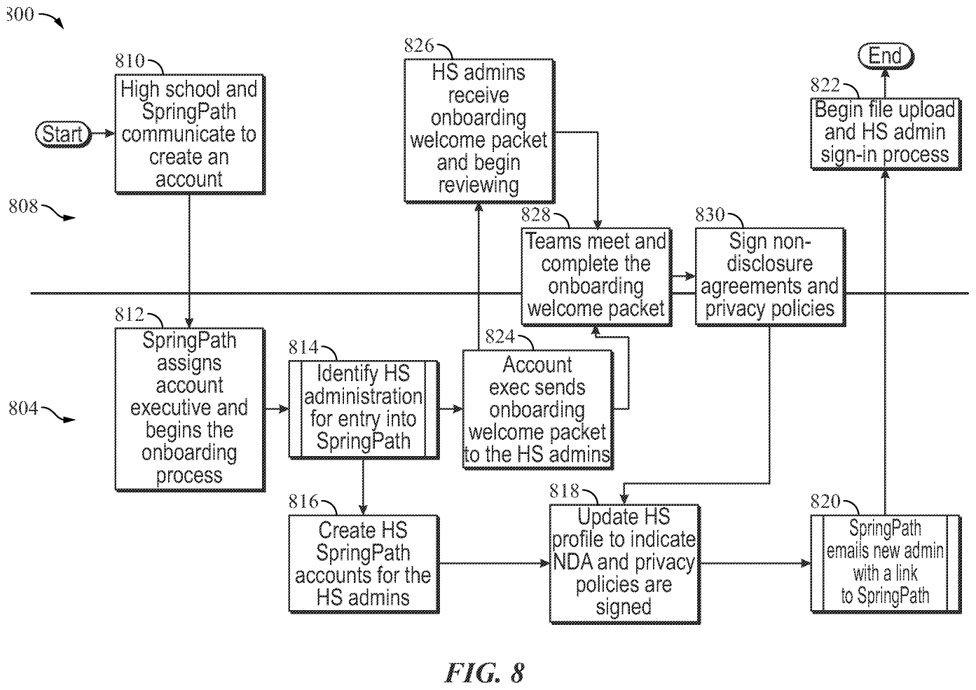

FIG. 8 is a flowchart diagram 800 showing a new high school onboarding process, in accordance with some embodiments described herein. As shown in the example embodiment, a high school 808 and the system 804 can be involved in the process. An initial step 810 can include the school 808 and the system 804 (via representative or automated process, online or offline) communicating and/or sharing information to create a school account. Once the system 804 has received the account information, in step 812 the system 804 can assign one or more account executive(s) to begin a school onboarding process. In step 814, one or more administrators at the school 808 can be identified, volunteered, and/or nominated by the school 808 or the system 804 for entry into the system 804. This identification can trigger or otherwise cause the system 804 to create system accounts for the high school administrator(s) in step 816, after which the system 804 can update a high school profile in step 818. This identification can also trigger or otherwise cause the account executive(s) to send onboarding and/or other materials, such as a welcome packet or information, to the high school administrator(s) in step 824. Once received, the administrator(s) can review the packet and schedule a time to meet with the account executive(s) (e.g., using a calendaring function or otherwise) in step 826. This meeting can be used to discuss any outstanding issues, go over the information in the welcome packet or other information, and/or discuss anything else and answer any questions in step 828. At or after the meeting (which can be held virtually over the platform in some embodiments), the high school administrator(s) can sign a non-disclosure agreement (NDA) and privacy policies in step 830. Next, in step 818 the high school profile can be updated to indicate that the NDA and privacy policies have been signed and the system 804 can notify (e.g., by email or otherwise) the new administrator(s) and send them a link to the system 804 in step 820. The high school administrator(s) are then able to begin uploading files and/or other information, and the administrator(s) are able to successfully complete a sign in process in step 822.

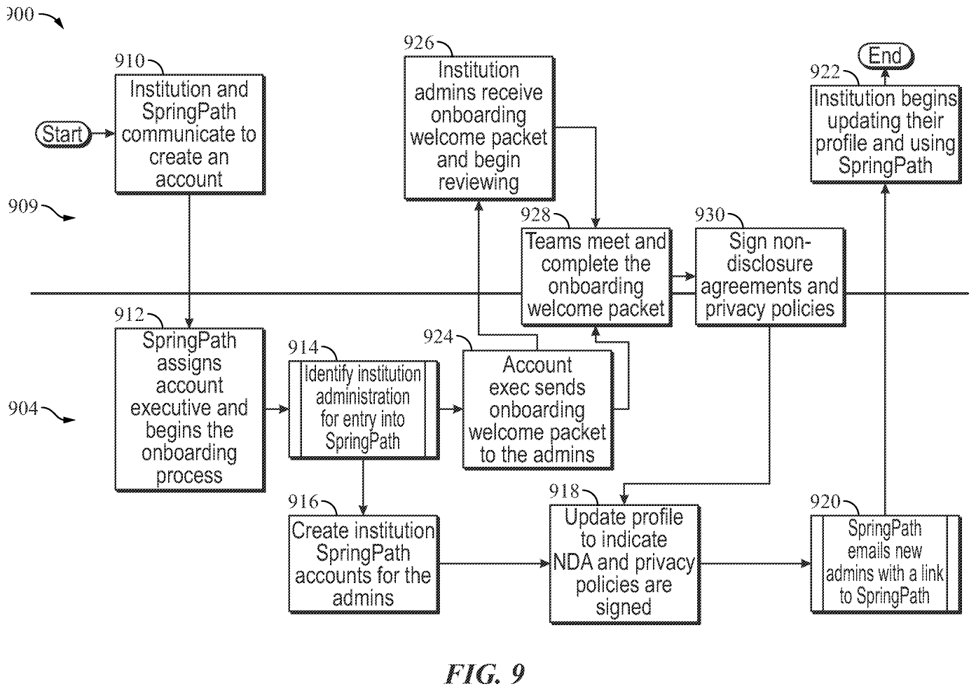

FIG. 9 is a flowchart diagram 900 showing a new institution onboarding process, in accordance with some embodiments described herein. As shown in the example embodiment, an institution 909 and the system 904 can be involved in the process. As shown in the example embodiment, an initial step 910 can include the institution 909 and the system 904 (via representative or automated process, online or offline) communicating and/or sharing information to create an institution account. Once the system 904 has received the account information, in step 912 the system 904 can assign one or more account executive(s) to begin an institution onboarding process. One or more administrators at the institution 909 can be identified, volunteered, and/or nominated by the school or the system 904 for entry into the system 904 in step 914. This identification can trigger or otherwise cause the system 904 to create system accounts for the institution's administrator(s), after which the system 904 can update an institution's profile in step 916. This identification can also trigger or otherwise cause the account executive(s) to send onboarding and/or other materials, such as a welcome packet or information, to the institution administrator(s) in step 924. Once received in step 926, the administrator(s) can review the packet and schedule a time to meet with the account executive(s) (e.g., using a calendaring function or otherwise). This meeting in step 928 can be used to discuss any outstanding issues, go over the information in the welcome packet or other information, and/or discuss anything else and answer any questions. At or after the meeting (which can be held virtually over the platform in some embodiments), in step 930 the institution administrator(s) can sign a non-disclosure agreement (NDA) and privacy policies. Next the institution's profile can be updated to indicate that the NDA and privacy policies have been signed in step 918 and the system 904 can notify (e.g., by email or otherwise) the new administrator(s) and send them a link to the system 904 in step 920. The institution administrator(s) are then able to begin uploading files and/or other information, and the administrator(s) are able to successfully complete a sign in process in step 922.

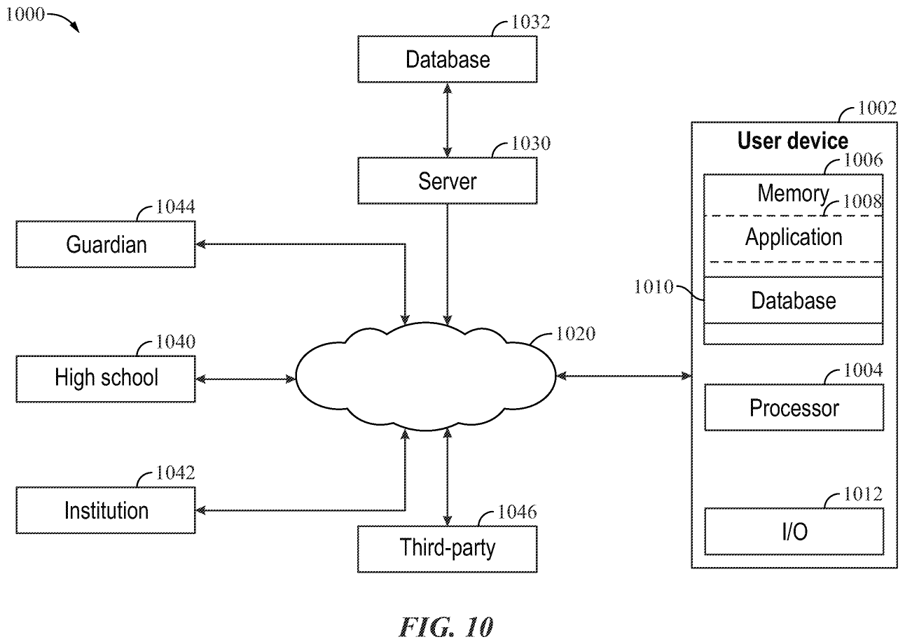

FIG. 10 is a system architecture diagram 1000, in accordance with some embodiments described herein. As shown in the example embodiment, a system architecture can include a user device 1002 (e.g., a smartphone or other mobile device, PDA, video game console, smart glasses, smartwatch, tablet computer, laptop computer, desktop computer, or other computing device). Such user device includes components including at least one processor 1004 and/or controller, memory 1006 (e.g., non-transitory computer readable media), user display(s), user interface(s) (e.g., keyboard, keypad, mouse, touchscreen, button(s)), audio component(s) (e.g., speaker(s), microphone(s), and/or other transceiver(s)), indicators (e.g., LED lights and others), power components, camera and/or video component(s), networking component(s), operating system(s), and/or other component(s), module(s), and attachment(s) as appropriate and connected to be functional and operable for the purposes described herein as understood by those skilled in the art and that are communicatively coupled to a wired and/or wireless network (e.g., the internet) 1020. Such device 1002 can receive and transmit information, display information, receive inputs from users, and interact with the system via the network 1020. Also shown is a server 1030 that can include a system of hardware and/or software that provides a network service via the network 1020 and can host information that is processed using at least one processor. The server 1030 can be communicatively coupled to at least one database 1032 that includes a collection of organized data stored in non-transitory computer readable media or memory and in some embodiments can be located on the server 1030, while in other embodiments the database 1032 can be located on one or more additional server(s) (not pictured) that are communicatively coupled to and/or otherwise accessible by or via the server 1030. As shown, high school(s) 1040, institution(s) 1042, guardian(s) 1044 and third-party(parties) 1046 can also be connected to the system using computer devices via the network 1020.

In some embodiments one or more system application(s) 1008 and/or computer program(s) can be downloaded and saved in memory 1006 on user device 1002. Processor(s) 1004 suitable for the execution of a computer program include both general and special purpose microprocessors and any one or more processors of any digital computing device. The processor 1004 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a tablet, a laptop, a desktop computer, a game console, a Global Positioning System (GPS) receiver, or a portable storage device (e.g., a universal serial bus (USB) flash drive).

A network interface and/or input output 1012 of device 1002 may be configured to allow data to be exchanged between the computer system and other devices attached to a network, such as other computer systems, or between nodes of the computer system. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 1006 may include an application 1008 and application instructions, configured to implement certain embodiments described herein, and a database 1010, comprising various data accessible by the application instructions. In one embodiment, the application instructions may include software elements corresponding to one or more of the various embodiments described herein. For example, application instructions may be implemented in various embodiments using any desired programming language, scripting language, or combination of programming languages and/or scripting languages (e.g., C, C++, C#, JAVA®, .NET, SGC, JAVASCRIPT®, PERL®, etc.).

The steps and actions of the computer system described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor such that the processor can read information from, and write information to, the storage medium. In the alternative, the storage medium may be integrated into the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, many connections can be associated with a computer-readable medium. For example, if the software is transmitted from a website, server, or other remote source using a coaxial cable, fiber optic cable, twisted pair, digital subscriber line (DSL), or wireless technologies such as infrared, radio, or microwave, then the coaxial cable, fiber optic cable, twisted pair, DSL, or wireless technologies such as infrared, radio, or microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, or other web network based, and the network server is a web server delivering HTML, XML, etc., web pages to the computing devices. In other embodiments, a client-server architecture may be implemented, in which a network server executes enterprise and custom software, exchanging data with custom client applications running on the computing device.

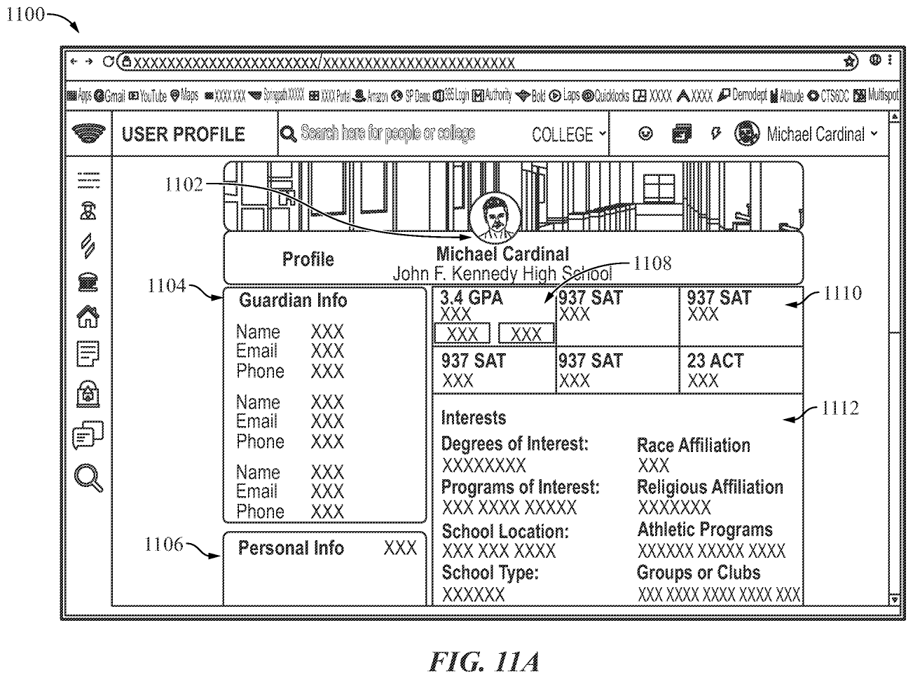

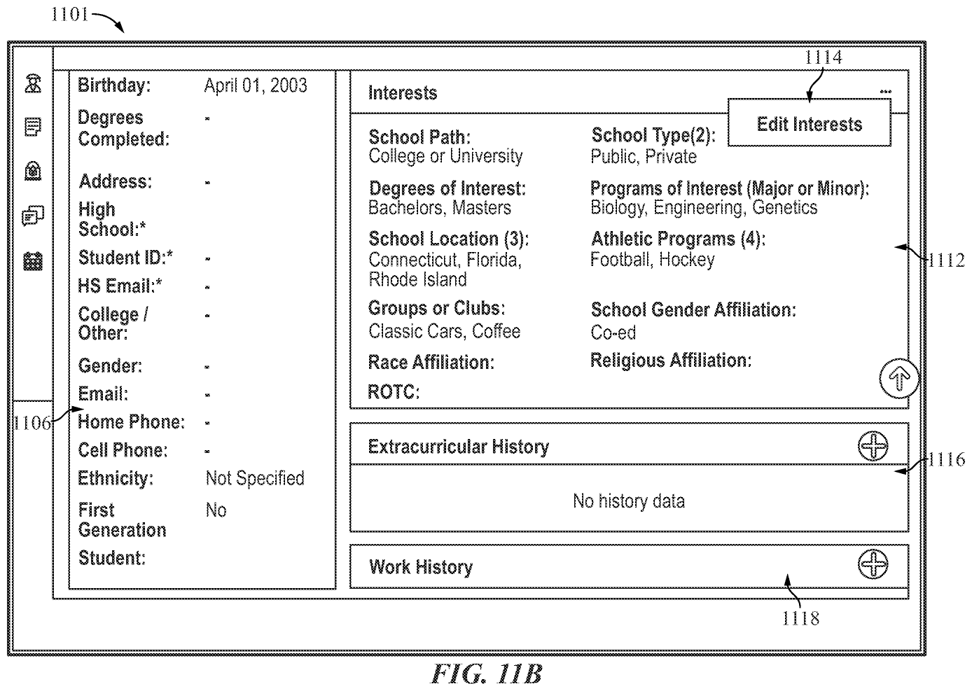

FIG. 11A is a user interface screenshot 1100 of a student profile, in accordance with some embodiments described herein. As shown in the example embodiment, once a student is granted access through the system validation process, they can begin filling out their profile. Information in a student profile page can include header information 1102 such as a name, a high school name, a banner image, a profile image, guardian information 1104 (e.g., name, contact information including email and/or telephone number and/or others), personal information 1106, grade point average (GPA) information 1108 (which can be further broken down by section such as math and/or English), standardized test scores 1110 (e.g., SAT, ACT, AP, IB, and/or their subparts and/or others), interests 1112 (e.g., degree interest, program interest, location interest, school type interest, race and/or ethnicity affiliation, religious affiliation, athletic programs, groups or clubs, and/or many other types of pertinent information). This information can be used to recommend and/or otherwise match the student with different schools and programs. In some embodiments coaches and/or scouts and/or players on a team can contact and discuss programs with students.

FIG. 11B is a user interface screenshot 1101 of a student profile, in accordance with some embodiments described herein. In some embodiments FIG. 11B can show a portion of a student profile (e.g., the one depicted in FIG. 11A), when a user scrolls down from the header sections. As shown, personal information 1106 can include birthday information, achieved degree information, address, high school, student identification number, high school email address, college or other information, gender, personal email, phone number(s), and/or many other types of personal information. Interests field 1112 can include school path (e.g., college or university), degrees of interest (e.g., associate, bachelors, masters, doctorate, or others), school location (e.g., state, region, city, or others), groups or clubs (e.g., classic cars, coffee, foreign language, travel, reading, writing poetry, or a myriad of others), race affiliation, ROTC, school type (e.g., public, private, religious, military, or others), programs of interest—major or minor (e.g., engineering, biology, genetics, law, international relations, or others), athletic programs (e.g., football, hockey, lacrosse, tennis, golf, or others), school gender affiliation (e.g., co-ed), religious affiliation, and/or others. Also shown is an edit interests button 1114. This selectable button can be displayed on the user interface if a user selects or hovers over a particular dropdown, for example an ellipses or other button appearance. Once selected, the edit interests button 1114 can cause the system to display selectable and modifiable fields, buttons, dropdowns, and other data entry and selection tools in various embodiments. An extracurricular history information section 1116 allows students to display relevant information. Similarly, a work history information section 1118 allows students to display relevant work history.

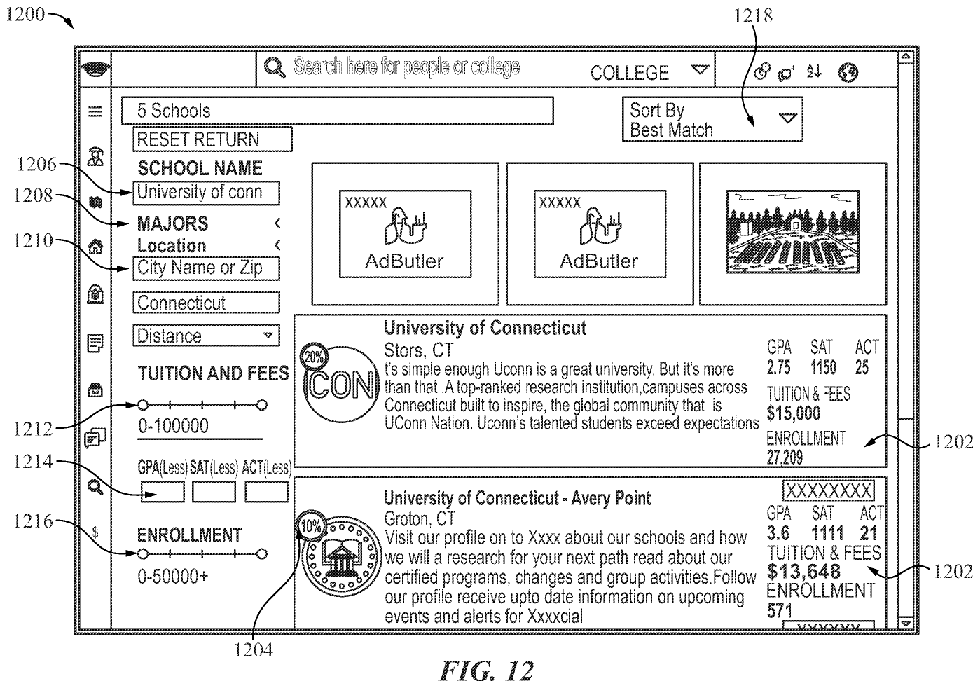

FIG. 12 is a user interface screenshot 1200 of a school recommendation page, in accordance with some embodiments described herein. As shown in the example embodiment, when students search for schools and programs using the system, they can be presented with various matches 1202 and indicators. Here, percentage indicators 1204 for particular schools and their programs based on the student's profile are presented via the user interface. A search field 1206 can allow the user to enter a school name, a majors tab 1208 can be a dropdown list, a location field 1210 can allow users to input a city name and/or zip code, a state, a region, and/or a distance. A tuition and fees bar 1212 can include one or more sliders to narrow or create a desired range. GPA, SAT, ACT and/or other test score field(s) 1214 can allow a student to input a minimum required value, an average value, or other values in various embodiments. One or more sliders 1216 can also be used for enrollment number values. Once a search has been entered, matches 1202 can be displayed by the system along with pertinent information, including school names, icons, other information, and percentages 1204. Additional information displayed can also include GPA, SAT, ACT, tuition and fees, enrollment, and many others. Users can also select individual schools to see how well they match with each school. Sorting indicator 1218 can be selected and will provide users with different sorting for their results, including by best match, closest location, and/or others.

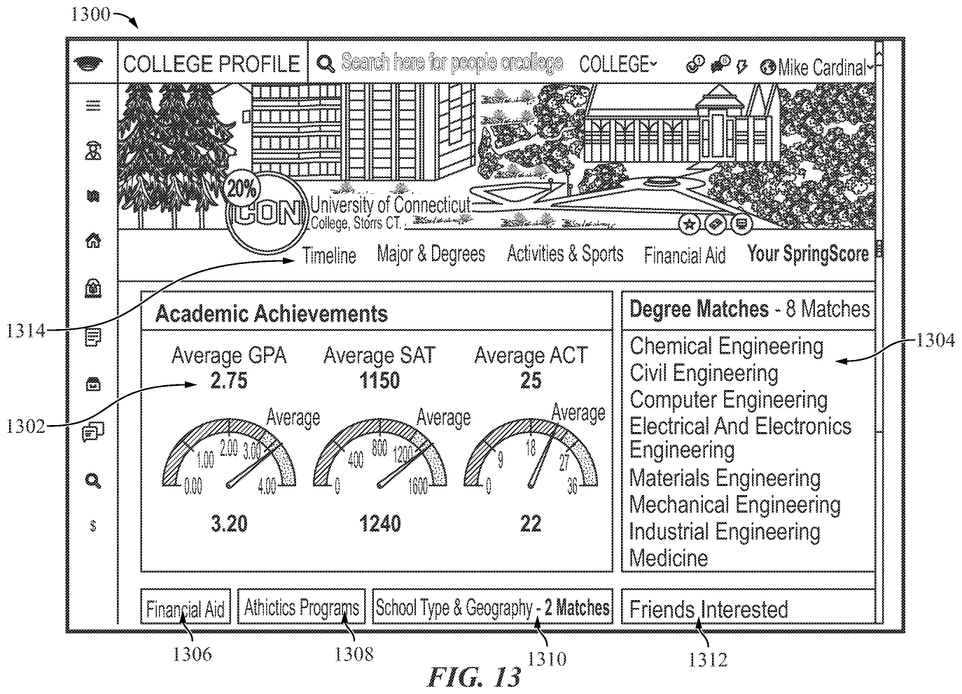

FIG. 13 is a user interface screenshot 1300 of a matching institution scoring page, in accordance with some embodiments described herein. As shown in the example embodiment, when a student selects a school profile to review additional information about the school (e.g., by selecting a match 1202 in the interface shown in FIG. 12), the system can show or display a matching institution scoring page with sections elaborating on the matching elements of the search, which adjust to show percentage or other metric matching information 1302 for students to review. Color coding can be used for visual impact and easy identification, such as green for good matches, red for misses or failures, and yellow for borderline cases. Additional fields can include degree matches 1304, financial aid 1306, athletics programs 1308, school type and geography 1310, friends interested 1312, and other information. Institution pages can also include buttons 1314 to access a timeline, majors and degrees, activities and sports, financial aid, and others.

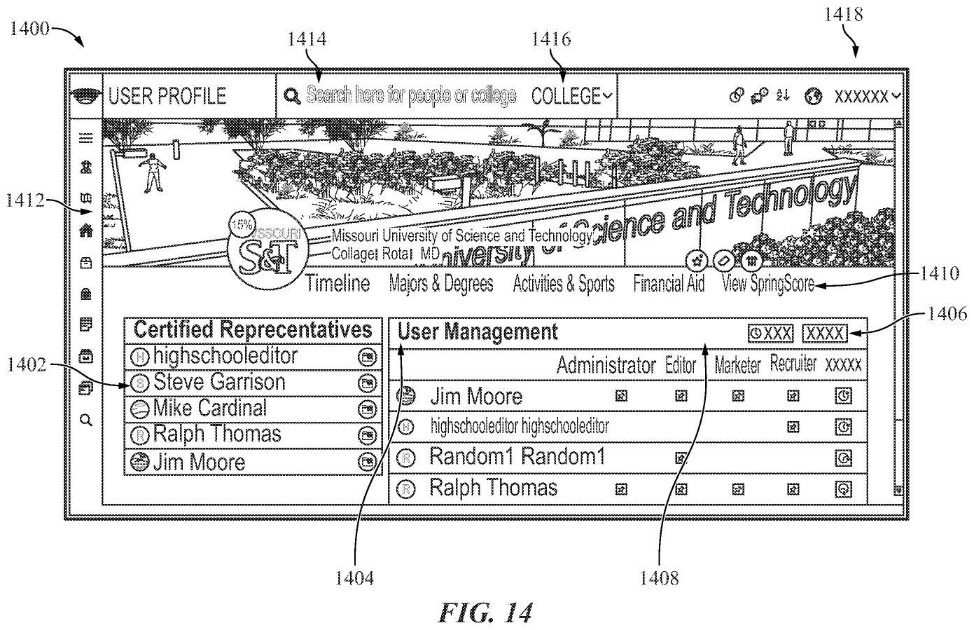

FIG. 14 is a user interface screenshot 1400 of a college/university or other school profile administrator, in accordance with some embodiments described herein. As shown in the example embodiment, school profile administrators can have different roles 1408 assigned to different users. These roles 1408 can include “recruiter,” “faculty,” or others, as defined by the system. This process can validate the user as a legitimate staff member of the school. When the user then logs in, they are appropriately credentialed and validated to interact with students who may be minors. Information in a school profile page can include a school name, profile image, banner image, location, and/or type of institution. Different tabs 1410 can be provided for interaction, including a timeline, major and/or degree, activities and sports, financial aid, system score, a list of certified users/representatives 1402, and user management section 1404 including names and roles with check boxes, radio buttons, or others, as appropriate. As shown, administrator, editor, marketer, recruiter and other roles can be included (e.g., coaches, counselors, or others) and additional buttons 1406 to add users, remove users, and otherwise modify accounts.

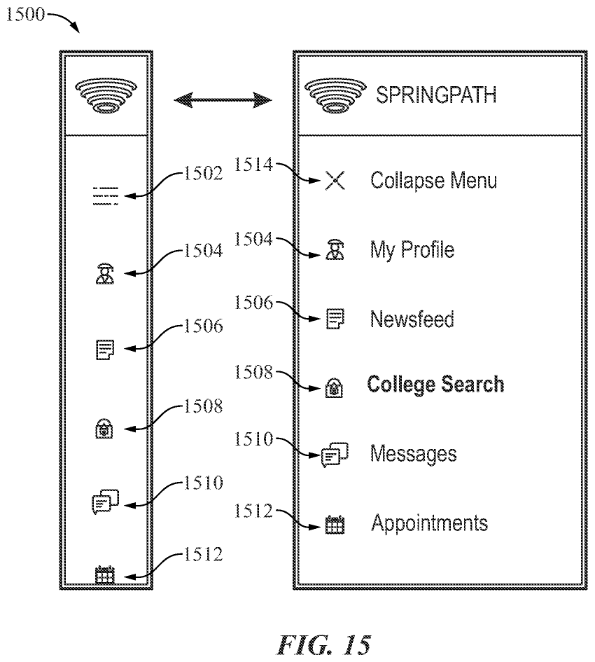

Also shown in FIG. 14 are system buttons 1412 (see FIG. 15 and related description for additional information) and search functionality with a search field 1414 with a drop down menu 1416 for selecting a school type. Additional buttons 1418 include a notification button, messages button, and user profile button.

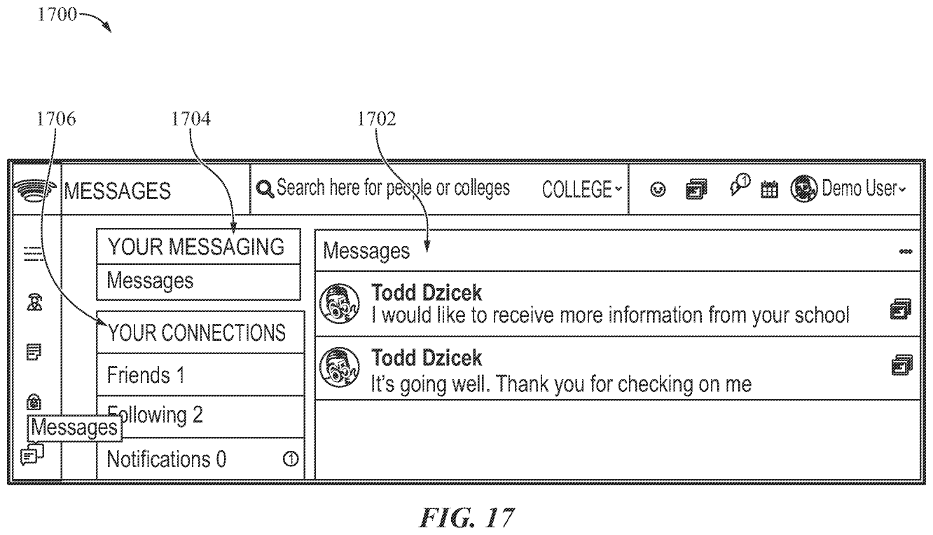

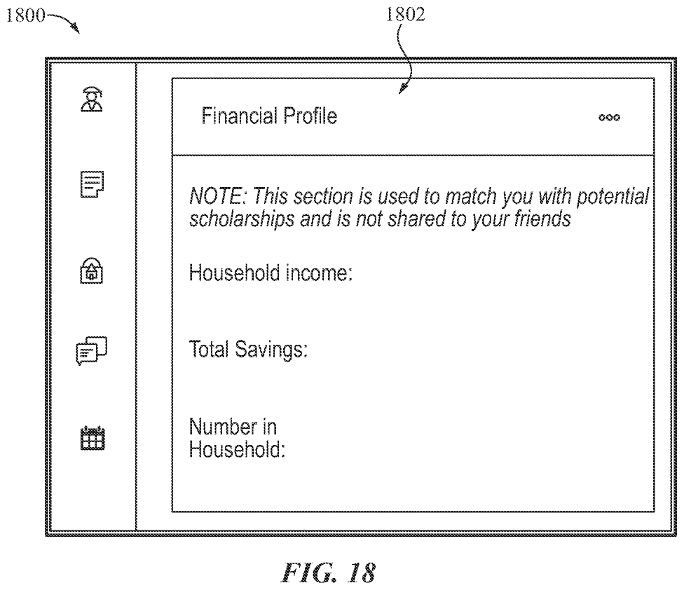

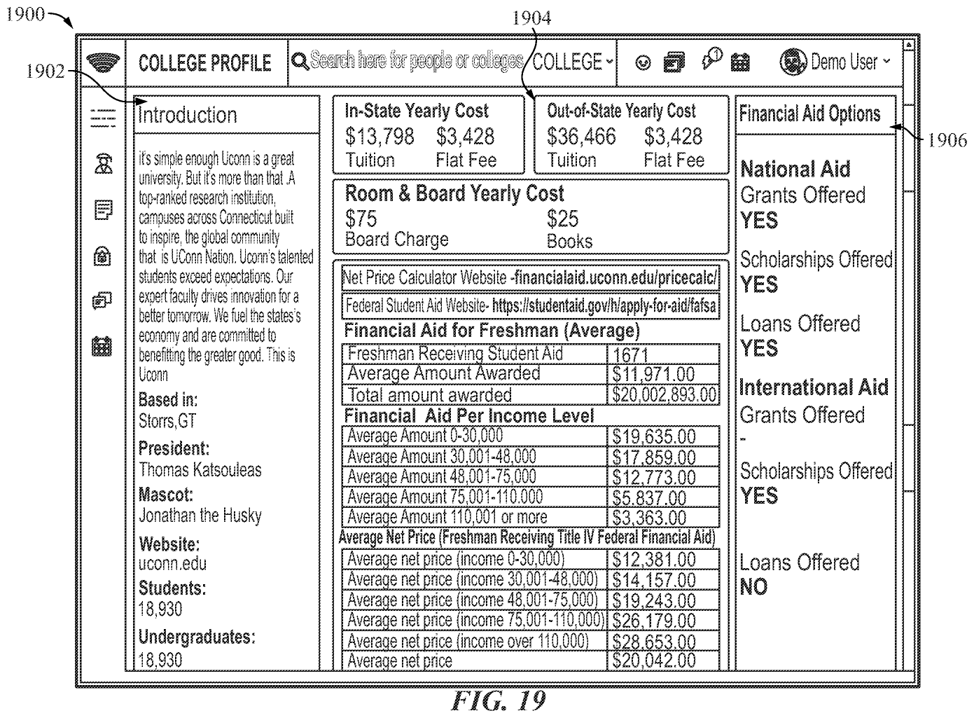

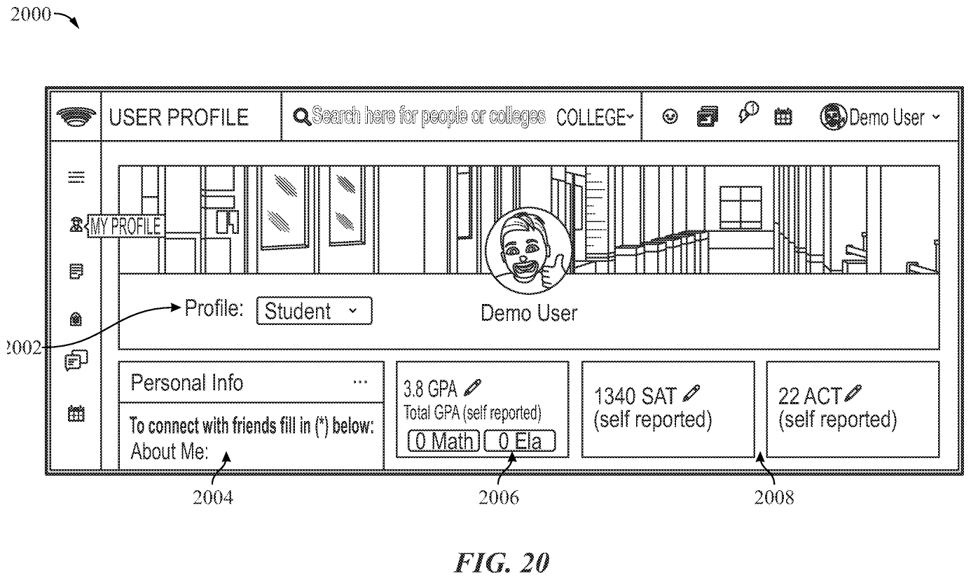

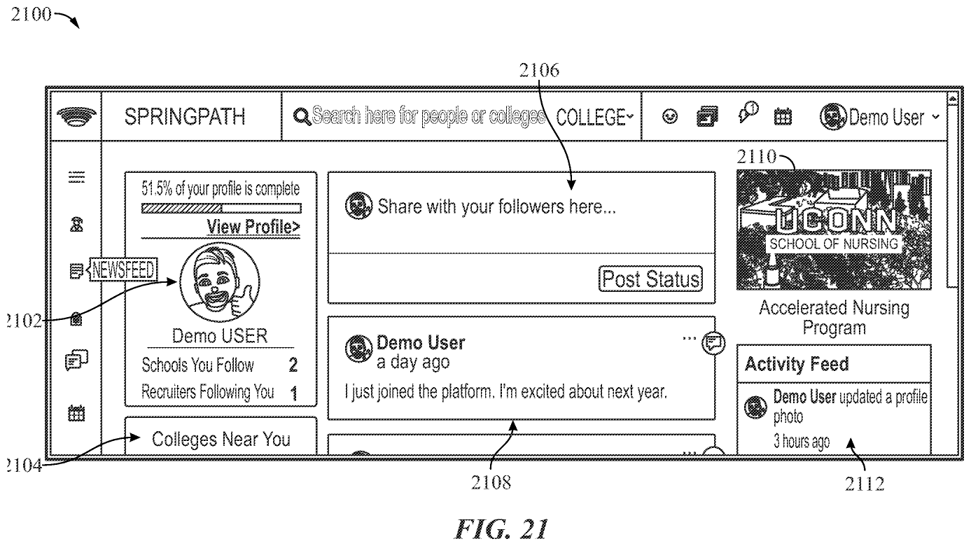

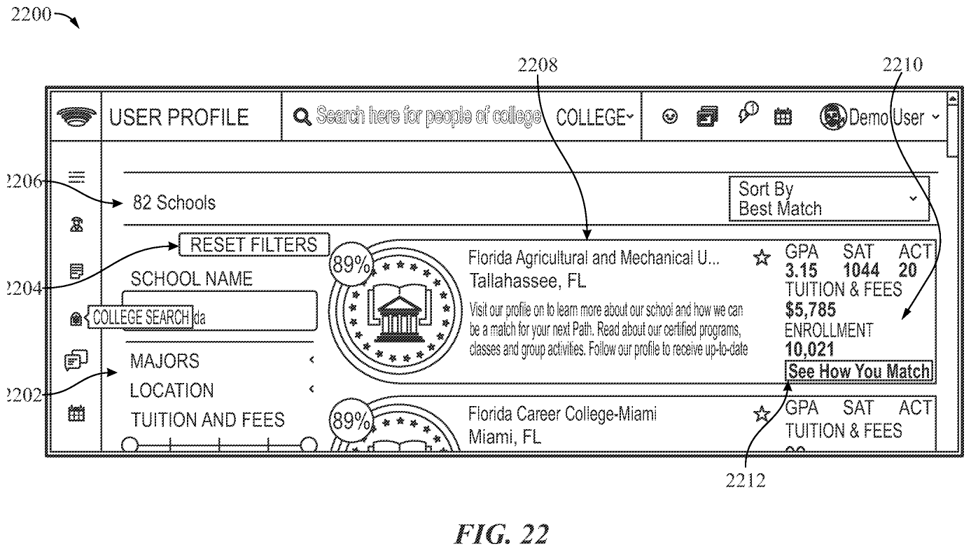

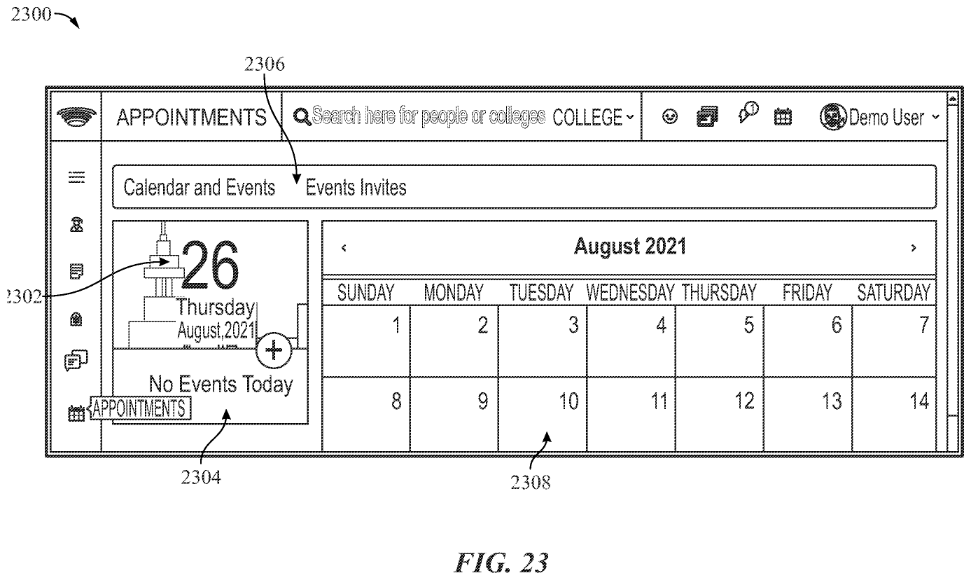

FIG. 15 is a user interface image of a system menu 1500 with system buttons, in accordance with some embodiments described herein. As shown in the example embodiment, an expand button 1502 can be selected by a user to view a full menu with descriptions, as shown on the right portion of FIG. 15. A my profile button 1504 can cause the system to display a logged in user's profile when selected (e.g., see FIGS. 18, 20 and associated descriptions). A newsfeed button 1506 can cause the system to display a newsfeed page when selected (e.g., see FIG. 21 and associated description). A college search button 1508 can cause the system to display a searching page when selected (e.g., see FIGS. 19, 22 and associated descriptions). A messages button 1510 can cause the system to display a messages screen when selected (e.g., see FIG. 17 and associated description). An appointments button 1512 can cause the system to display a calendar and/or appointments page when selected (e.g., see FIG. 23 and associated description). A collapse menu button 1514 can cause the menu to collapse into a truncated portion (e.g., at the left portion of FIG. 15).

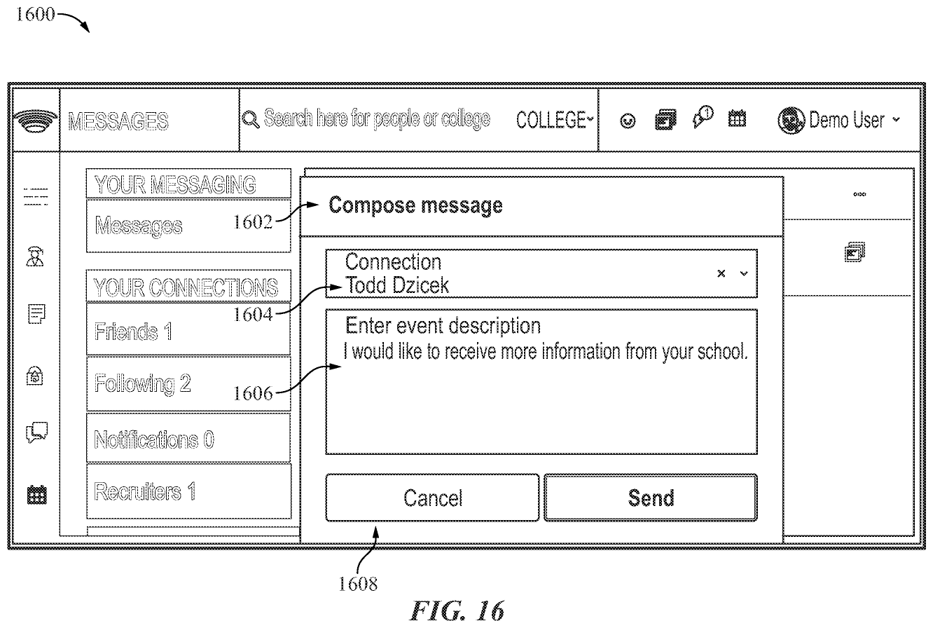

FIG. 16 is a user interface screenshot 1600 of a message composition window, in accordance with some embodiments described herein. As shown in the example embodiment, a message composition window 1602 can be displayed when a user selects a message composition button in some embodiments. A message composition window 1602 can include a recipient field 1604, which in some embodiments can include a drop down menu of connections the user has made through the platform, administrators or others with public profiles at institutions the user is interested in, or others. A message field 1606 can allow a user to enter letters, numbers, characters, emojis, pictures, video, audio clips, and/or other information that they wish to send to a recipient, in various embodiments. Buttons 1608 can include a send button, cancel button, and others.

FIG. 17 is a user interface screenshot 1700 of a message management page, in accordance with some embodiments described herein. As shown in the example embodiment, a message management page can include a thread or conversation window 1702, which can be displayed when a user selects a message management button in some embodiments. Conversation window 1702 can include a list of conversation threads that a user has had through the system. These can allow users to view and interact with threads by selecting display buttons associated with each individual thread. Identifying information such as names, institution affiliations, profile pictures, and others can be included. Also included can be a your messaging tab 1704, which can allow users to sort different types of messages. A your connections tab 1706 can include buttons that allow users to view and sort messages from friends, people they are following, system and/or institution notifications, and others in various embodiments. When new messages have been received, indicator numbers can also be included, as can colors, shapes, and other components and elements that draw the user's attention.

FIG. 18 is a user interface screenshot 1800 of a financial profile page, in accordance with some embodiments described herein. As shown in the example embodiment, a financial profile page can include a financial profile tab or window 1802, which can be displayed when a user selects a financial profile button in some embodiments. Financial profile window 1802 can include information and messages related to an individual user's financial information. This financial information can include household income, total savings, number of people/students/parents/guardians in the household and a variety of other related financial information.

FIG. 19 is a user interface screenshot 1900 of an institution profile page, in accordance with some embodiments described herein. As shown in the example embodiment, an institution profile page can include an introduction tab 1902 with basic information about the institution, including a description of the institution's history, athletic and academic programs, location, ranking, leader information, mascot name, website, number of students, number of undergraduates, and/or other information. Financial information tabs 1904 can include in-state and out-of-state costs such as tuition and flat fees, room and board annual costs, financial aid for freshmen information, financial aid per income level, average net price, and others, as appropriate. Financial aid options tab 1906 can include national and international aid information including information about grants, scholarships, loans, whether scholarships and loans are offered, and others.

FIG. 20 is a user interface screenshot 2000 of a student profile page, in accordance with some embodiments described herein. As shown in the example embodiment, a student profile page can include a profile picture, name, and banner information 2002. It can also include a personal information tab 2004 with an about me section, age, athletics, interests, and other appropriate information. A GPA section 2006 can include an overall GPA as well as broken down GPA by subject. A standardized test score section 2008 can indicate test scores and whether the scores are verified or self reported.

FIG. 21 is a user interface screenshot 2100 of a newsfeed page, in accordance with some embodiments described herein. As shown in the example embodiment, a newsfeed page can include a user information section 2102. User information section 2102 can include a percentage or amount indicator of how much the associated user's profile is filled out. It can also include a button link to view the user's profile, profile image, user's name, number of institution's followed quantity, recruiters following the user quantity, and/or other information. Also included is a colleges near you section 2104 which can be populated with a list of institutions in close geographic proximity to the user. A posting field 2106 can allow the user to enter information in the form of text, audio, video, photographic, and others in various embodiments and include or be near a post button. A user feed 2108 can include information such as posts by the user, posts by other users, posts by institutions, posts by recruiters, posts by the user's high school, and other information. An advertisement section 2110 can include targeted ads to the user. An activity feed 2112 can include a list of activities the user has engaged in recently, such as changing a profile picture, posting an update, or others. In some embodiments advertisements are moderated by the system prior to display. In such embodiments, advertisers may send potential advertisements to the system and once approved, such advertisements may be displayed. In some embodiments institutions can upload virtual tours, videos, and images that can be seen by students.

FIG. 22 is a user interface screenshot 2200 of an institution search page, in accordance with some embodiments described herein. As shown in the example embodiment, a search page can include a filters section 2202, whereby a user can filter search results by a number of different metrics, including majors, locations, tuitions and fees, school name, and others. These filters can be in the form of drop down menus, data fields, scroll bars, and others. A reset filters button 2204 removes a current set of filters and shows the results in their default formatting. A results quantity 2206 shows the number of matching search results for a particular search that a user has performed. A search results list 2208 can include tabs for individual institutions 2210 that match the search criteria. These tabs 2210 can include school names, locations, information, percentage match based on filters, average and/or minimum GPAs, standardized test scores, tuition and fees, enrollment numbers, and/or other information in various embodiments. A see how you match button 2212 can cause the system to display metrics that it calculates about how the user's information matches with the institution on a number of different levels.

FIG. 23 is a user interface screenshot 2300 of an appointments page, in accordance with some embodiments described herein. As shown in the example embodiment, an appointments page can include a current date display 2302, an event adding button, and an current date event list 2304. A calendar and events line 2306 can show event invites for the user. A calendar 2308 can include selectable and interactive event information buttons in some embodiments that are arranged according to date and time on a digital calendar screen.

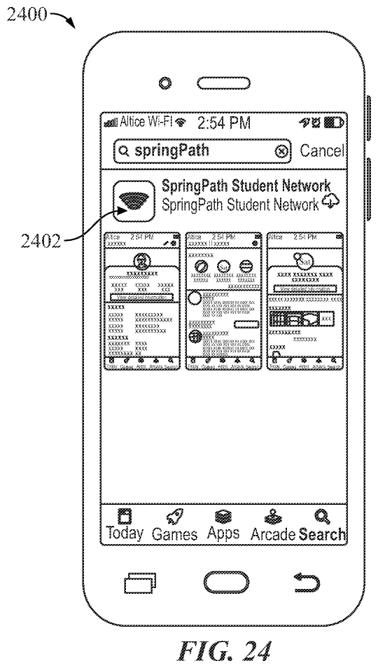

FIG. 24 is a user interface screenshot 2400 of a mobile device store, in accordance with some embodiments described herein. As shown in the example embodiment, a user can search in a mobile device store and find a system description, icon, and downloadable application (also referred to herein as an app) 2402.

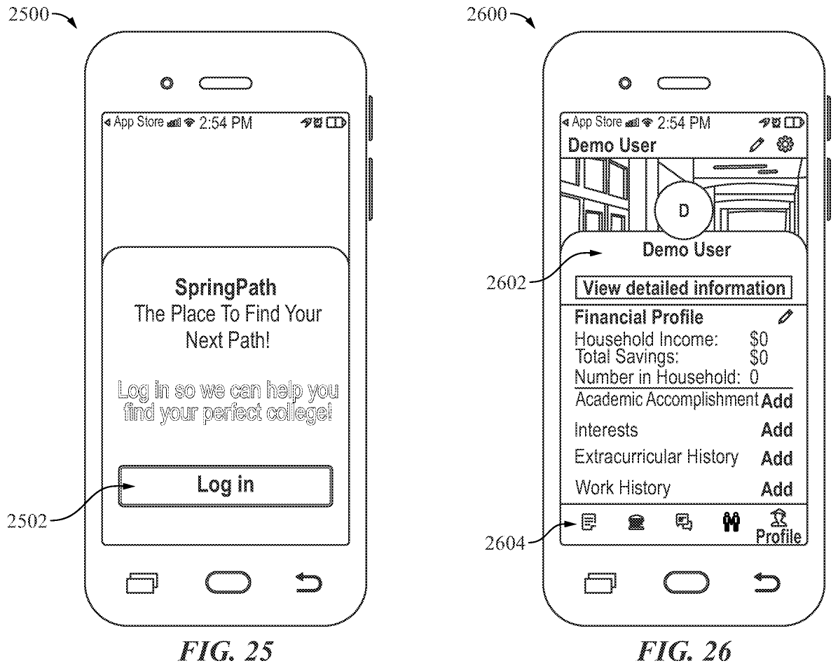

FIG. 25 is a user interface screenshot 2500 of a system application login screen, in accordance with some embodiments described herein. As shown in the example embodiment, once a user has downloaded a system app, they can access the system using a log in button 2502. This can cause the mobile device to access a user's personal profile via a communicatively coupled network, whereby various notifications, search functions, chat functions, data presentations, and other information can be pushed to and/or pulled to the associated mobile device and otherwise exchanged with system servers.

FIG. 26 is a user interface screenshot 2600 of a system application user profile screen, in accordance with some embodiments described herein. As shown in the example embodiment, a user can access their profile after downloading an app and logging in. A user profile 2602 can include analogous information to that which is displayed, editable, and interactive through a web portal on mobile and other types of network connected devices (e.g., see FIGS. 11A-11B and 20 and associated descriptions). Also included are system interaction buttons 2604 that are analogous to those in FIG. 15 and have similar functionality. In some embodiments, users can display information about which institution they have committed to based on their preference and selecting an affiliated button or field.

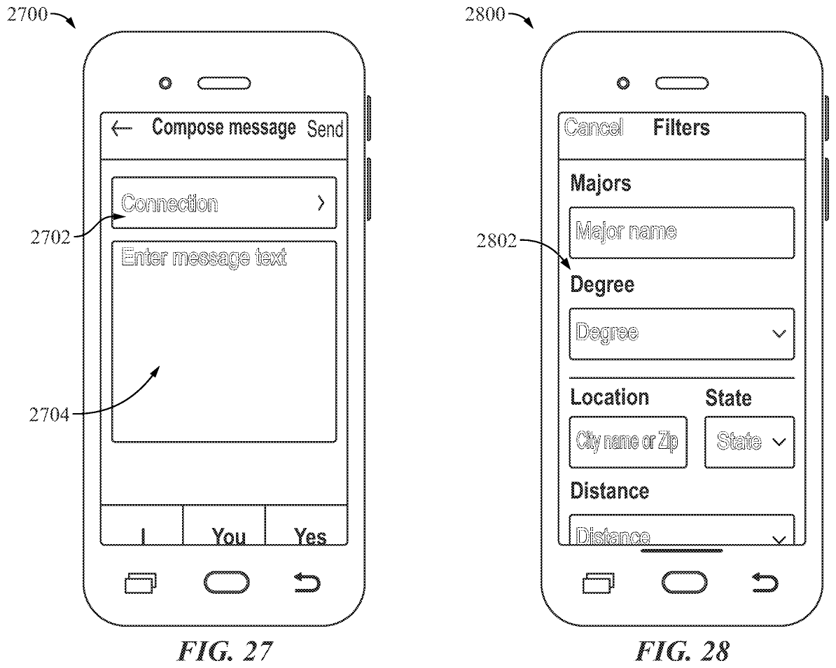

FIG. 27 is a user interface screenshot 2700 of a system application messaging screen, in accordance with some embodiments described herein. Such screen has analogous functionality to that shown and described with respect to FIG. 16. A user connection 2702 can be a recruiter, administrator, or other person that the user has made a connection with through the system and can be selected from a dropdown menu or typed in by a user. A message field 2704 allows the user to enter messages, images, videos or otherwise enter communications before selecting a send button. Users can also select a back button to return to a previous screen.

FIG. 28 is a user interface screenshot 2800 of a system application institution search filter screen, in accordance with some embodiments described herein. Such screen has analogous functionality to that shown and described with respect to FIGS. 12 and 22. Filter fields and dropdown menus 2802 allow users a great deal of control over their institution searching.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

I/We claim:

1. A system for validating minors on a higher education learning platform, comprising:
a server of the system receiving a student's request, via a network, to create an account with the system;
the server determining whether the student is a non-emancipated minor; and
if the student is a non-emancipated minor, the server transmits, via the network, a consent request to the student's guardian.

2. The system for validating minors on a higher education learning platform of claim 1, wherein the server determines whether the student is a minor by calculating the students age and comparing the age with a threshold value for adulthood.

3. The system for validating minors on a higher education learning platform of claim 1, further comprising:
upon receiving a consent confirmation from the student's guardian, the system transmits, via the network, an approval message to the student.

4. The system for validating minors on a higher education learning platform of claim 1, further comprising:
if the student is an emancipated minor, the server allowing access to the emancipated minor.

5. The system for validating minors on a higher education learning platform of claim 1, further comprising:
if the guardian declines the consent request, transmitting, via the network, a message to the student that their request has been declined.

6. The system for validating minors on a higher education learning platform of claim 1, further comprising:
a high school transmitting, via the network, information regarding the student to the system server.

7. The system for validating minors on a higher education learning platform of claim 1, wherein the system is operable to create a user profile for the student.

8. The system for validating minors on a higher education learning platform of claim 7, further comprising:
upon entry of at least one search criteria by the student, the system determining institutions that match the at least one criteria.

9. The system for validating minors on a higher education learning platform of claim 8, wherein the at least one criteria is a geographic location.

10. The system for validating minors on a higher education learning platform of claim 8, wherein the at least one criteria is a standardized test score.

11. A computer implemented method for validating minors on a higher education learning platform, comprising steps stored in memory which, when executed by a processor of a server cause the server to:
create an account with the system upon receiving a student's request at the server, via a computer network;
determine whether the student is a non-emancipated minor; and
if the student is a non-emancipated minor, transmit, via the network, a consent request to the student's guardian.

12. The computer implemented method of claim 11, wherein the server determines whether the student is a minor by calculating the student's age and comparing the age with a threshold value for adulthood.

13. The computer implemented method of claim 11, further comprising:
transmits, via the network, an approval message to the student upon receiving a consent confirmation from the student's guardian.

14. The computer implemented method of claim 11, further comprising:
allowing access to the emancipated minor if the student is an emancipated minor.

15. The computer implemented method of claim 11, further comprising:
transmit, via the network, a message to the student that their request has been declined if the guardian declines the consent request.

16. The computer implemented method of claim 11, further comprising:
receiving, via the network, information regarding the student from a high school at the server.

17. The computer implemented method of claim 11, wherein the server is operable to create a user profile for the student.

18. The computer implemented method of claim 17, further comprising
upon entry of at least one search criteria by the student, determining institutions that match the at least one criteria.

19. The computer implemented method of claim 18, wherein the at least one criteria is a geographic location.

20. The computer implemented method of claim 18, wherein the at least one criteria is a standardized test score.
